(19) United States
(12) Patent Application Publication
(10) Pub. No.: US 2012/0318597 A1
(43) Pub. Date: Dec. 20, 2012

(54) Portable Winch Stow Plate

(75) Inventor: Bryan Yoder, Corvallis, OR (US)

(73) Assignee: WARN INDUSTRIES, INC., Clackamas, OR (US)

(21) Appl. No.: 13/162,943

(22) Filed: Jun. 17, 2011

(51) Int. Cl. B62K 11/00; F16M 13/02

(52) U.S. Cl. 180/219; 248/674

(57) ABSTRACT

A stow plate is provided for supporting a winch having a pair of drum supports, at least one tie rod extending between the pair of drum supports, a drum rotatably supported between the pair of drum supports and a motor for rotatably driving the drum. The stow plate includes a plate having at least one hook extending from a surface of the plate. At least one mounting flange extends from the plate at a spaced location from the hook, wherein the hook is adapted to be engageable with the at least one tie rod of the winch and the at least one mounting flange includes a first aperture adapted to be aligned with a second aperture associated with at least one of the pair of drum supports. A mounting pin is adapted to be removably received in the first and second apertures for securing the winch to the stow plate.

### FIELD

The present disclosure relates to a portable winch and more particularly to a portable winch stow plate mounting system.

### BACKGROUND

This section provides background information related to the present disclosure which is not necessarily prior art.

Winches are commonly used with off-road recreational vehicles to assist a user in freeing a vehicle from being stuck or for assisting the vehicle up a hill or out of a ditch. In many off-road recreational vehicles, the winch can be mounted to a front bumper or to a winch carrier mounted to the front of a vehicle. Off-road motorcycles and other vehicles may not have adequate space or weight balancing to accommodate a winch being mounted to a front end thereof. Accordingly, it is desirable to provide a device for securely stowing a portable winch while not in use.

### SUMMARY

This section provides a general summary of the disclosure, and is not a comprehensive disclosure of its full scope or all of its features.

A vehicle is provided including a vehicle body and at least two wheels supporting the vehicle body. A motor is provided for driving at least one of the at least two wheels of the vehicle. A stow plate is mounted to the vehicle body and a winch is releasably mounted to the stow plate. The stow plate can be mounted directly to the vehicle body via body panels or the frame, or can be mounted to a storage rack, luggage carrier, or other accessory on the vehicle. A luggage carrier includes, but is not limited to, a Pannier, tail bags, or tank bags. The vehicle can include a motorcycle.

According to a further aspect of the present disclosure, a stow plate is provided for supporting a winch having a pair of drum supports, at least one tie rod extending between the pair of drum supports, a drum rotatably supported between the pair of drum supports and a motor for rotatably driving the drum. The stow plate includes a plate having at least one hook extending from a surface of the plate. At least one mounting flange extends from the plate at a spaced location from the hook, wherein the hook is adapted to be engageable with the at least one tie rod of the winch and the at least one mounting flange includes a first aperture adapted to be aligned with a second aperture associated with at least one of the pair of drum supports. A mounting pin is adapted to be removably received in the first and second apertures for securing the winch to the stow plate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a rear perspective view of a motorcycle having a winch mounted thereto by a stow plate according to the principles of the present disclosure;

FIG. 2 is a perspective view of the stow plate;

FIG. 3 is top plan view of the stow plate;

FIG. 4 is a side plan view of the stow plate;

FIG. 5 is a rear plan view of the stow plate;

FIG. 6 is a side view illustrating a winch prior to being mounted to the stow plate;

FIG. 7 is a side view illustrating the winch being engaged to the hook of the stow plate; and

FIG. 8 is a side view illustrating the winch mounted to the stow plate.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

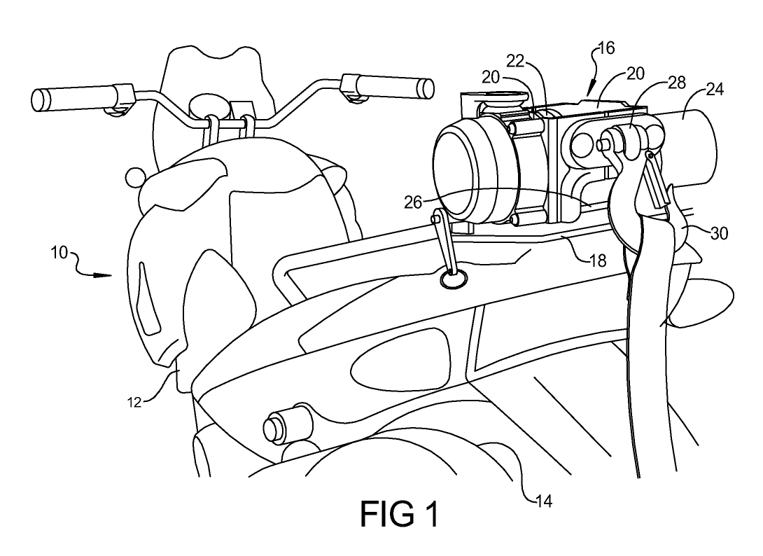

With reference to FIG. 1, a motorcycle 10 is shown including a body 12 supported by a plurality of wheels 14. The motorcycle can include a motor for driving at least one of the plurality of wheels 14. A portable winch 16 is mounted to a stow plate 18 that is mounted to the body 12.

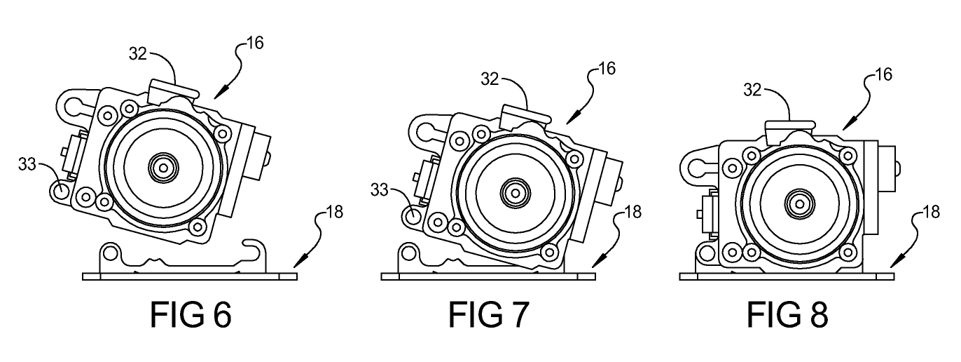

The winch 16 generally includes a pair of drum supports 20, a drum 22 rotatably supported between the pair of drum supports 20, and a motor 24 for rotatably driving the drum 22. One or more tie rods 26 can extend between the pair of drum supports 20. A cable 28 is wound onto, and can be reeled from, the drum 22, and can support a hook 30 at a distal end thereof. A clutch lever 32 is mounted to a gear box of the winch 16. The winch 16 can be designed to be portable, and can include a handle to assist in its portability. As best shown in FIG. 6, the winch 16 can be provided with one or more mounting apertures 33 associated with the drum support, as will be described in greater detail herein.

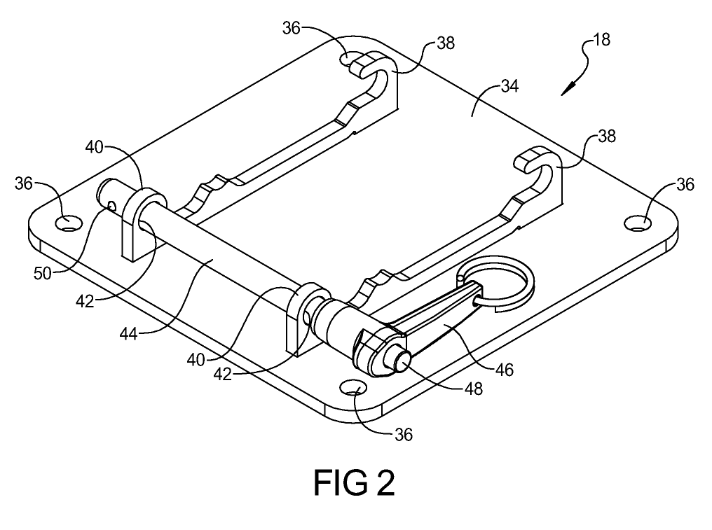

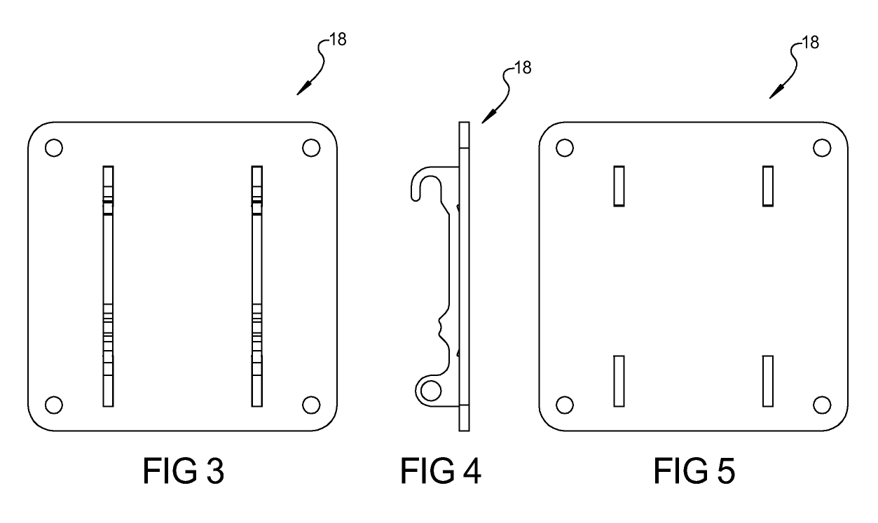

The stow plate 18, as best illustrated in FIGS. 2-5, can include a generally flat plate 34, including a plurality of mounting apertures 36 extending therethrough. A hook 38 extends from a surface of the plate 34, and a pair of mounting flanges 40 also extend from the plate 34 and are spaced from the hook 38. The mounting flanges 40 each include an aperture 42 therein for receiving a mounting pin 44. The mounting pin 44 can include a handle 46 and a release mechanism in the form of a push button 48 that can be depressed to release a spring biased locking pin 50 to allow removal of the mounting pin 44 from the apertures 42. It is noted that the hook 38 and mounting flanges 40 can be integrally formed with the plate 44, or can be inserted into mounting apertures in the plate and then staked therein or otherwise secured thereto by welding or other fastening techniques.

As illustrated in FIGS. 6-8, the winch 16 can be mounted to the stow plate 18. A tie rod 26, to be received by the hook 38, is generally illustrated by FIG. 1. The apertures 33 associated with the drum supports 20 of the winch 16 are then aligned with the apertures 42 provided in the mounting flanges 40 of the stow plate 18. The mounting pin 44 is then inserted through the apertures 42 in the mounting flanges, as well as the apertures 33 associated with the drum supports 20 in order to securely mount the winch 16 to the stow plate 18.

The stow plate 18 can be mounted to a vehicle such as the motorcycle 10 in FIG. 1 utilizing the mounting apertures 36 and appropriate fasteners for securing the stow plate 18 to the body of the vehicle 10. Although the stow plate 18 is shown in combination with a motorcycle 10, it should be appreciated that the stow plate 18 could be mounted to various vehicles such as all-terrain vehicles, utility vehicles, recreational vehicles, tow trucks, and other types of vehicles for stowing a winch thereon during non-use. The stow plate can be mounted to the vehicle body via the frame or body panels, or can be mounted to a storage rack, a hard or soft luggage carrier, or other accessory on the vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle, comprising:
a vehicle body;
at least two wheels supporting said vehicle body;
a motor for driving at least one of said at least two wheels;
a stow plate mounted to said vehicle body; and
a winch mounted to said stow plate.

2. The vehicle according to claim 1, wherein said vehicle is a motorcycle.

3. The vehicle according to claim 2, wherein said at least two wheels include a front wheel and a rear wheel and said stow plate is mounted above said rear wheel.

4. The vehicle according to claim 1, wherein said stow plate is mounted directly to said vehicle body.

5. The vehicle according to claim 1, wherein said stow plate is mounted to a rack on said vehicle

6. The vehicle according to claim 1, wherein said stow plate is mounted to a luggage carrier on said vehicle.

7. The vehicle according to claim 1, wherein said stow plate includes a plate fastened to said vehicle, a hook extending from a surface of said plate and at least one mounting flange extending from said plate at a spaced location from said hook, wherein said winch includes a pair of drum supports, at least one tie rod extending between said pair of drum supports, a drum rotatably supported between said pair of drum supports and a motor for rotatably driving said drum, said hook being engageable with said at least one tie rod and said at least one mounting flange including a first aperture adapted to be aligned with a second aperture associated with at least one of said pair of drum supports and a pin removably received in said first and second apertures for securing said winch to said stow plate.

8. The vehicle according to claim 1, wherein said winch is releasably mounted to said stow plate.

9. The vehicle according to claim 1, wherein said stow plate includes a plurality of mounting apertures therein for securing said stow plate to said vehicle body.

10. A stow plate for supporting a winch having a pair of drum supports, at least one tie rod extending between the pair of drum supports, a drum rotatably supported between the pair of drum supports and a motor for rotatably driving said drum, said stow plate comprising:
a plate;
at least one hook extending from a surface of said plate;
at least one mounting flange extending from said plate at a spaced location from said at least one hook, wherein said at least one hook is adapted to be engageable with the at least one tie rod of a winch and said at least one mounting flange including a first aperture adapted to be aligned with a second aperture associated with at least one of the pair of drum supports; and
a mounting pin adapted to be removably received in said first and second apertures for securing the winch to said stow plate.

11. The stow plate according to claim 10, wherein said at least one mounting flange includes a pair of spaced mounting flanges.

12. The stow plate according to claim 10, wherein said plate includes a plurality of mounting apertures therein.

13. The stow plate according to claim 11, wherein said plate is generally flat.

14. The stow plate according to claim 10, wherein said at least one hook is open in a direction facing said at least one mounting flange.
